(19) United States
(12) Patent Application Publication
(10) Pub. No.: US 2007/0275144 A1
(43) Pub. Date: Nov. 29, 2007

(54) Method for selective isolation of valuable products

(76) Inventor: Johann Wiesmuller, Garching (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/557,449

(22) PCT Filed: May 19, 2004
(86) PCT No.: PCT/EP04/05436

§ 371 Date: Sep. 12, 2006

(30) Foreign Application Priority Data
May 20, 2003 (DE) 10322564.1

(51) Int. Cl. A23L 1/22

(52) U.S. Cl. 426/534

(57) ABSTRACT

The invention relates to a method for the selective isolation of valuable substances with the aid of compressed C2 to C4 hydrocarbons, such as for example ethane, propane, and/or butane, according to which a starting material is used, which contains the valuable substances in an absorbed and/or adsorbed form. Activated carbon, alumina, silicic acids, zeoliths or polysaccharides, which are charged accordingly with the valuable materials, are used as the starting materials for said method, which is carried out preferably in a continuous operation at temperatures of </=120 DEG C. and pressures of <50 Mpa. The inventive method is particularly suitable for obtaining high-quality aromas and flavourings from starting materials that are derived from the production and/or preparation of foodstuffs and preferably from the preparation of flavourings, the production and processing of juices, wines and spirits, or the processing of meat, fruit and vegetables.

The present invention relates to a method for the selective isolation of valuable products using compressed C2 to C4 hydrocarbons.

In the production of foods and drinks, in particular in liquid form, such as juices, wines and spirits, but also in the processing of solid raw materials and foodstuffs, such as meat, fruit and vegetables, large amounts of liquid or solid process streams are produced which are supplied either as waste or as secondary raw materials, for example as feedstuffs, to animal husbandry, or are further processed, for example by appropriate clarification and clean-up measures.

Thus, for example from the clarification of fruit juices, loaded adsorbents are produced which customarily are disposed of, since clean-up of the loaded adsorbents is uneconomic.

The described use of adsorbents, such as activated carbon or kieselguhr, in the food industry is only one example of many.

However, it is disadvantageous with all established methods which use adsorbents that selective isolation is not performed by the adsorbents used, but, in accordance with the specific surface areas of the adsorbents, valuable products present in the process streams, e.g. flavor substances and aroma substances, are also bound to the adsorbents, for which reason these generally also comprise significant amounts of these valuable products. Hitherto, no economic methods are known which make it possible, for example, to isolate valuable products bound to the adsorbents selectively in the form of flavor substances and aroma substances, and lead to further creation of value.

Thus, for the recovery of flavor substances and aroma substances in the context of corresponding extraction methods, lipophilic organic solvents are also used. The flavor substances and aroma substance concentrates obtained in this manner, however, usually comprise a large fraction of residues of the organic solvents used, which leads to an easily understandable impairment in product qualities.

For further purification of the flavorings and aroma substance products which are extracted using organic solvents, therefore, likewise adsorption materials are used which are to remove the organic solvent residues from the products, but which purification, owing to the physical properties of the adsorbents used, proceeds only inadequately in selective quality, and for which reason the flavor substance and aroma substance concentrates are adversely depleted by the adsorbents with respect to the constituents with sensory activity.

Most recently, numerous methods have also been described in which the flavor substances are extracted by compressed gases, in particular by supercritical carbon dioxide. At this point, by way of example, reference may be made to European patent EP 0 065 106, in which a method for producing concentrated aroma substance and flavoring extracts by extraction with carbon dioxide at supercritical pressure and subcritical temperature is described. These methods are currently of great interest, in particular owing to their gentle process conditions and the high selectivity of the solvent, since very high quality grade flavorings can be produced using them.

For the isolation of a fat/oil fraction from a flavoring fraction, various processing routes can be taken: firstly, fractional extraction may be used, in which the different constituents are extracted from the natural material sequentially by different method parameters, such as pressure, temperature or entrainer feed, and collected separately. Secondly, fractional precipitation comes into consideration, in which, although the various constituents are first extracted together, they are then precipitated from the gas under different conditions.

However, attempts have also been made for the recovery of natural flavor substances to precede the pure CO2 extraction with an extraction using liquid propane and/or butane, in order, in this manner, to isolate selectively the oil and fat components which are especially highly critical in sensory terms and only then to carry out the actual flavor extraction (DE A 44 40 644). In this method, which is carried out in the first stage at temperatures □70° C. and at pressures □50 MPa, it has proved, however, when it is implemented on an industrial scale, that it can be carried out exclusively with solids, and in addition only in the case of natural substances which comprise the natural flavor substances at a high concentration. Successful flavor extraction of liquid and semiliquid (viscous) starting materials and those having a low flavor substance content is not possible with this two-stage method, however.

The known prior art has thus made the general object for the present invention to provide a method for the selective isolation of valuable products using compressed C2 to C4 hydrocarbons by which the desired products are obtained in good quality and a relatively simple manner.

This object is achieved by a corresponding method in which a starting material is used which comprises the valuable products in an absorbed and/or adsorbed state.

“Absorption” in the context of the present invention is taken to mean binding of valuable products by liquids or solid substances. “Adsorption” denotes the corresponding addition of valuable products in the dissolved state to solid bodies, the adsorption being directly proportional to the surface area of the solid adsorption body used.

Surprisingly, on implementation of the inventive method under practical conditions, it was found that not only can valuable products be selectively isolated from adsorption materials customarily used in the purification of liquid foods, but that it is possible to refine flavor substances and aroma substances from marketable end products further by adding adsorption materials to these end products, as a result of which the valuable flavor substances and aroma substances are bound and these are then selectively isolated from the adsorption materials in accordance with the inventive method. Overall, purity and quality of the resultant valuable products are increased many fold. This was not to be expected to this extent.

The present method is suitable in particular for valuable products which are flavor substances and/or aroma substances. However, the valuable products can also be present in the form of organic intermediates or end products, as are obtained in particular using biotechnological methods. These include especially fermentation methods. The valuable products, however, can also be bound to catalysts, in this case, not only the actual valuable products being obtained, but also the purified support materials.

The inventive method is preferably carried out at temperatures of □120° C. and pressures of <50 MPa, in which case the temperature, particularly preferably, should be between 20 and 40° C., and the pressure between 0.5 and 10 MPa.

Suitable C2 to C4 hydrocarbons have proved to be, in particular, compressed ethane, propane, butane or mixtures thereof, the present invention envisaging, in certain applications, adding to the compressed hydrocarbon (mixture) entrainers, such as dimethyl ether or alcohols, preferably in amounts of 0.5 to 50% by weight, further preferably 5 to 20% by weight.

The inventive method is particularly suitable for batchwise procedure. Depending on the respective field of use, the method claimed, however, can also be carried out continuously or semicontinuously.

With respect to the starting material, solid substances having high internal and/or external surface areas have been found to be suitable, and in this case preferably those having surface areas >0.1 m2/g, preferably >10 m2/g, further preferably >100 m2/g, and still further preferably >500 m2/g (in accordance with BET DIN 66131) and/or fluid substances. Suitable solid substances are considered to be, in particular, activated carbons, aluminas, silicas, kieselguhr, aluminosilicates, zeolites and/or polysaccharides, such as cyclodextrins.

With respect to their origin, the present method takes into account, in particular, starting materials which originate from food production and/or food recovery or from flavor recovery, but also from production and processing of juice, wine and spirits, and/or from processing of meat, fruit and vegetables.

Particularly advantageously, the inventive method has proven itself in the recovery of natural, nature-identical and/or synthetic flavor substances and aroma substances, which the present invention likewise takes into account.

The invention likewise comprises methods in which flavor substances and aroma substances are obtained in liquid or pasty form, or else as powder. The flavor substances and aroma substances can, in the context of the inventive method, finally be dissolved, which should preferably take place in alcohol.

The claimed method reveals its advantageous properties in particular when it is carried out in a separation column or in another suitable pressure vessel, in which case, with respect to the separation column used, it has proved to be particularly advantageous when the method is carried out by the countercurrent flow principle.

Overall, the present invention also provides that the pressure vessel can be coupled to a separator and the extracted valuable products can be isolated, for example, in the form of flavor substances and aroma substances, preferably by pressure reduction and/or temperature elevation. The inventive method also makes possible the recirculation of the hydrocarbons used as extraction media, which additionally contributes to its economic efficiency.

Finally, the invention further provides for a special method variant in which an adsorption step is provided upstream of the actual method: in this variant, first solid substances having high internal and/or external surface areas >0.1 m2/g, preferably >10 m2/g, further preferably >100 m2/g, and still further preferably >500 m2/g (BET DIN 66131) are loaded with valuable products; this loaded complex is then treated as described with compressed C2 4 hydrocarbons.

On account of the extent of possible starting materials and their origin, the present method together with its preferred variants is suitable not only for the selective isolation of adsorbed or absorbed flavor substances and aroma substances from support materials which only comprise these valuable products on account of the insufficient selectivity of the adsorbents, rather this method can also be used for producing high sensory quality flavoring or aroma concentrates, by, for example, admixing commercially conventional concentrates which were obtained using organic solvents or compressed CO2 with an adsorbent. By this means, key sensory compounds are selected from the concentrate and, then, the adsorbents thus loaded can be treated as claimed. In this manner, typical key compounds of the flavor substances and aroma substances are selectively concentrated, which leads to high-quality end products.

However, the present invention also takes into account the isolation of less valuable compounds which are bound to adsorption or absorption materials. With this variant, the principle focus is thus on recovery or purification of the support materials, and less on the substances adsorbed or absorbed thereon.

In this case, preferably, the isolation or purification of catalysts or silica gels, but also of support materials as are used in methods for gas scrubbing, are to be taken into account.

In summary, it can be stated that by the novel method, in particular valuable products can be selectively removed from a starting material to which they are adsorbed or absorbed, and obtained in high quality grades, which is of interest, in particular, with respect to the additional increase in quality of commercially conventional products.

The examples hereinafter verify the advantages of the inventive method for the selective isolation of valuable products using compressed C2 to C4 hydrocarbons.

### EXAMPLES

### Example 1

Isolation of a Black Tea Flavoring From Activated Carbon from Tea Decaffeination.

1 kg of loaded activated carbon from black tea decaffeination (CO2 high-pressure process) was extracted at 30 bar and 30° C. with a total of 5 kg of liquid propane. The extract, after pressure reduction, was precipitated at 8 bar and 46° C., which produced 320 mg of a pasty, light-brown extract. This extract was then dissolved in 16 g of absolute ethanol. The sensory properties showed a pleasant flowery, typical black tea aroma.

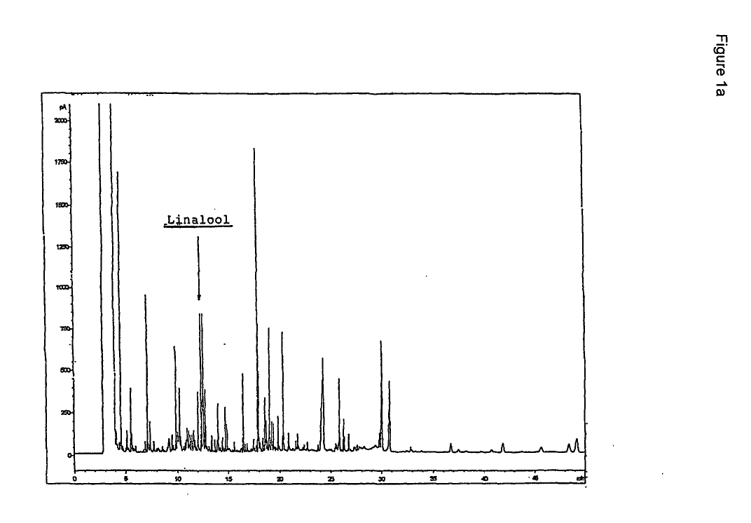

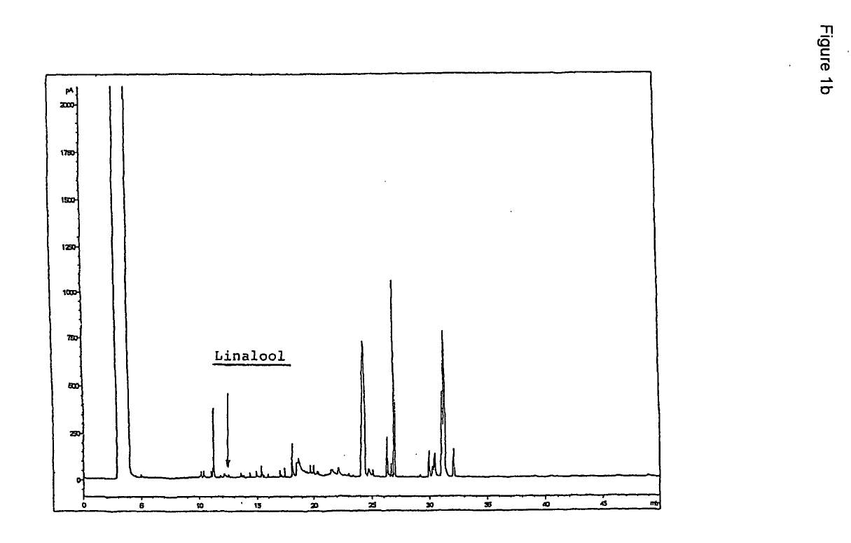

One of the principal sensory components of the flavoring of black tea is linalool (linalyl alcohol). Gas chromatographic determination of linalool content of a tea flavoring from activated carbon according to invention (a) found, compared with a conventional black tea flavoring (b) recovered by ethanol extraction, the following values:

| | | |
|---|---|---|
| a) | tea flavoring from | 2% strength in absolute ethanol: 168 mg of |
| | activated carbon | linalool/l (FIG. 1a) |
| b) | tea flavoring from | 50% strength in ethanol: <5 mg of |
| | ethanol extraction | linalool/l (FIG. 2a) |

### Example 2

Isolation of a Raspberry Flavoring from Kieselguhr from Raspberry Juice Clarification.

1.56 kg of loaded kieselguhr of pasty consistency from clarification of raspberry juice were centrifuged: as centrifugate, 560 g of juice were isolated. The residue of 1 kg was extracted with 6 kg of liquid propane at 30 bar and 35° C. The extract, after pressure reduction, was precipitated at 6 bar and 48° C., which produced 15 mg of a pasty white extract. This extract was dissolved in 7.5 g of absolute ethanol.

Result of the flavor evaluation: intensely fruity, after 2 to 3 minutes raspberry-like, fruity, sweet, fruit-typical, long-lasting, pure aroma.

1-22. (canceled)

23. A method for the selective isolation of valuable products using compressed C₂ to C₄ hydrocarbons, characterized in that a starting material is used which comprises valuable products in an absorbed and/or adsorbed state, the valuable products being flavorings, flavor substances and/or aroma substances, organic intermediates or end products, preferably from biotechnological methods, or valuable products which are bound to catalysts.

24. The method as claimed in claim 1, characterized in that it is carried out at temperatures of ≦120° C. and pressures of <50 MPa.

25. The method as claimed in claim 1, characterized in that the temperature is set to 20 to 40° C., and the pressure is set to 0.5 to 10 MPa.

26. The method as claimed in claim 1, characterized in that compressed ethane, propane, butane or mixtures thereof are used.

27. The method as claimed in claim 1, characterized in that entrainers such as dimethyl ether or alcohols are added to the compressed hydrocarbon (mixture) in amounts of 0.5 to 50% by weight.

28. The method as claimed in claim 1, characterized in that it is carried out batchwise.

29. The method as claimed in claim 1, characterized in that, as starting material, use is made of solid substances having high internal and/or external surface areas, preferably having surface areas >0.1 m²/g (BET DIN 661311) and/or fluid substances.

30. The method as claimed in claim 7, characterized in that use is made of activated carbons, aluminas, silicas, kieselguhr, aluminosilicates, zeolites and/or polysaccharides, such as cyclodextrins.

31. The method as claimed in claim 1, characterized in that use is made of starting materials which originate from food production and/or food recovery or from flavor recovery, production and processing of juice, wine and spirits, and/or processing of meat, fruit and vegetables.

32. The method as claimed in claim 1, characterized in that natural, nature-identical and/or synthetic flavor substances and aroma substances are obtained.

33. The method as claimed in claim 1, characterized in that the flavor substances and aroma substances are obtained in liquid or pasty form, or as powder.

35. The method as claimed in claim 1, characterized in that the flavor substances and aroma substances are finally dissolved, preferably in alcohol.

36. The method as claimed in claim 1, characterized in that it is carried out in a separation column, preferably by the countercurrent flow principle.

37. The method as claimed in claim 13, characterized in that the pressure vessels are coupled to a separator and the extracted flavor substances and aroma substances are preferably isolated by pressure reduction and/or temperature elevation.

38. The method as claimed in claim 13, characterized in that the hydrocarbons are recirculated.

39. The method as claimed in claim 1, characterized in that, in addition to the valuable products, the starting materials having high internal and/or external surface areas are recycled and/or further utilized.

40. The method as claimed in claim 39, characterized in that the starting materials are catalysts or silica gels.

41. The method as claimed in claim 40, characterized in that the starting materials are support materials from gas scrubbing.

42. A method for concentrating valuable products, characterized in that solid substances having high internal and/or external surface areas >0.1 m²/g (BET DIN 66131) are loaded with valuable products and are then subjected to a method as claimed in claim 1.
